(19) United States
(12) Patent Application Publication
(10) Pub. No.: US 2010/0332341 A1
(43) Pub. Date: Dec. 30, 2010

(54) Credit System for Collection of Recycled Materials

(75) Inventor: John M. Rost, Orland Park, IL (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: CROWN PACKAGING TECHNOLOGY, INC., Alsip, IL (US)

(21) Appl. No.: 12/823,624

(22) Filed: Jun. 25, 2010

Related U.S. Application Data
(63) Continuation-in-part of application No. 12/492,771, filed on Jun. 26, 2009, now abandoned.

(51) Int. Cl. G06Q 50/00; G06Q 30/00; G06Q 10/00

(52) U.S. Cl. 705/26; 705/308; 705/317

(57) ABSTRACT

A method of an administrator recording a sale and a retiring of a recycling credit certificate for a recycled material may include the steps of a computing device at the administrator: receiving from a seller a request to generate the recycling credit certificate, transferring the certificate from an account registered by the seller to an account registered by the buyer, receiving from the buyer a request to retire the recycling credit certificate, and recording the certificate as retired. The certificate may include unique information identifying environmental attributes that are unbundled from a corresponding amount of a recycled material. The request to retire the certificate may include an amount of standard manufactured material used in an amount of product bearing a retail product claim for the environmental attributes that were unbundled from the corresponding amount of the recycled material tangibly owned by the seller.

### CROSS-REFERENCE TO RELATED APPLICATIONS

This application is a continuation in part of U.S. patent application Ser. No. 12/492,771, filed Jun. 26, 2009, the disclosure of which is hereby incorporated by reference as if set forth in its entirety herein.

### TECHNICAL FIELD

The present invention relates to credit systems and, more particularly, to a credit system for collection of recycled materials, and methods relating to same.

### BACKGROUND

The production and use of recycled material has several environmental benefits compared to the production and use of virgin or standard manufactured material. For example, the process of producing recycled metal is typically much less expensive and energy-intensive than the process of producing standard manufactured metal by mining, extracting, and refining the metal material. However, some metal forming companies may find that using recycled metal may cost more for a given amount than standard manufactured metal, depending on, for instance, the transportation cost of the metal from the metal producer to the metal forming company. Similarly, the process of producing recycled paperboard, plastic, and glass also represents significant energy savings as well as air pollution savings.

For these reasons, it may be beneficial for companies that produce materials that may be recycled, or companies that purchase components from these companies, to market their products to end users as containing a portion of recycled material. However, given geographical, cost, or other limitations, it may be difficult for a given company to quantify or specify the recycled material in its products.

### SUMMARY

A credit system for collection of recycled materials, and methods relating to the credit system for collection of recycled materials are disclosed. The credit system and methods disclose a way for companies that produce materials that may be recycled, such as aluminum beverage can or steel packaging manufacturers, paperboard manufacturers, plastic manufacturers, or glass manufacturers, to obtain the marketing benefits of stating that their products contain a portion of recycled material, without actually requiring the these companies to specify the amount of recycled material content used in particular retail products.

This type of system is especially important in the metal industry because recycled metal is typically indistinguishable from virgin or standard manufactured metal (e.g., no loss of function or capability in recycled metal compared to standard manufactured metal). For this reason, the collection and introduction of recycled material into the overall metal manufacturing stream would have the same environmental benefit no matter which metal forming company eventually incorporates that recycled metal into its retail products.

A method of an administrator recording a sale and a retiring of a recycling credit certificate for a recycled material may include the steps of a computing device at the administrator: receiving from a seller a request to generate the recycling credit certificate, transferring the certificate from an account registered by the seller to an account registered by the buyer, receiving from the buyer a request to retire the recycling credit certificate, and recording the certificate as retired. The certificate may include unique information identifying environmental attributes that are unbundled from a corresponding amount of the recycled material, the corresponding amount of the recycled material being tangibly owned by the seller. The request to retire the certificate may include an amount of standard manufactured material used in an amount of product bearing a retail product claim for the environmental attributes that were unbundled from the corresponding amount of the recycled material tangibly owned by the seller.

The recycled material and the standard manufactured material may, by way of example, include aluminum, steel, paperboard, plastic, or glass and at least one of the buyer and the seller may also be aluminum, steel, paperboard, plastic, or glass packaging manufacturers. The method may also include the computing device at the administrator receiving from a recycling center an amount of the recycled material that was produced by the recycling center. The method may also include the computing device at the administrator subtracting the amount of the recycled material tangibly owned by the seller from the amount of the recycled material that was produced by the recycling center. The method may also include the computing device at the administrator verifying that the result of subtracting the amount of the recycled material tangibly owned by the seller from the amount of the recycled material that was produced by the recycling center is equal to zero. The method may also include the computing device at the administrator establishing the account registered by the seller and the account registered by the buyer. The method may also include the computing device at the administrator receiving from the seller a request to list in an electronic market system the amount of the recycled material. The method may also include the computing device at the administrator listing the amount of the recycled material in the electronic market system.

The method may also include the computing device at the administrator receiving from an auditor an amount of the recycled material that was claimed to be used in retail products shipped by the buyer. The method may also include the computing device at the administrator subtracting the amount of the recycled material tangibly owned by the seller from the amount of the claimed to be used recycled material that was received from the auditor. The method may also include the computing device at the administrator verifying that the result of subtracting the amount of the recycled material tangibly owned by the seller from the amount of the claimed to be used recycled material that was received by the auditor is equal to zero. The account registered by the seller may also be located in a computing device at another credit system administrator. The method may also include the computing device at the administrator generating and electronically sending a report to the buyer, the report including the recording of the certificate as retired.

A computer-readable storage medium may have computer instructions for recording a sale and a retiring of a recycling credit certificate for a recycled material stored thereon, that when executed by an administrator's processor, perform the instructions including: receiving from a seller a request to generate the recycling credit certificate, transferring the certificate from an account registered by the seller to an account registered by the buyer, receiving from the buyer a request to retire the recycling credit certificate, and recording the certificate as retired. The certificate may include unique information identifying environmental attributes that are unbundled from a corresponding amount of the recycled material, the corresponding amount of the recycled material being tangibly owned by the seller. The request to retire the certificate may include an amount of standard manufactured material used in an amount of product bearing a retail product claim for the environmental attributes that were unbundled from the corresponding amount of the recycled material tangibly owned by the seller.

The recycled material and the standard manufactured material may also be aluminum, steel, paperboard, plastic, or glass and at least one of the buyer and the seller may also be aluminum, steel, paperboard, plastic, or glass packaging manufacturers. The computer-readable storage medium may also have computer instructions, that when executed by an administrator's processor, perform the instructions including receiving from a recycling center an amount of the recycled material that was produced by the recycling center. The computer-readable storage medium may also have computer instructions, that when executed by an administrator's processor, perform the instructions including subtracting the amount of the recycled material tangibly owned by the seller from the amount of the recycled material that was produced by the recycling center. The computer-readable storage medium may also have computer instructions, that when executed by an administrator's processor, perform the instructions including verifying that the result of subtracting the amount of the recycled material tangibly owned by the seller from the amount of the recycled material that was produced by the recycling center is equal to zero. The computer-readable storage medium may also have computer instructions, that when executed by an administrator's processor, perform the instructions including establishing the account registered by the seller and the account registered by the buyer. The computer-readable storage medium may also have computer instructions, that when executed by an administrator's processor, perform the instructions including receiving from the seller a request to list in an electronic market system the amount of the recycled material. The computer-readable storage medium may also have computer instructions, that when executed by an administrator's processor, perform the instructions including listing the amount of the recycled material in the electronic market system.

The computer-readable storage medium may also have computer instructions, that when executed by an administrator's processor, perform the instructions including receiving from an auditor an amount of the recycled material that was claimed to be used in retail products shipped by the buyer. The computer-readable storage medium may also have computer instructions, that when executed by an administrator's processor, perform the instructions including subtracting the amount of the recycled material tangibly owned by the seller from the amount of the claimed to be used recycled material that was received from the auditor. The computer-readable storage medium may also have computer instructions, that when executed by an administrator's processor, perform the instructions including verifying that the result of subtracting the amount of the recycled material tangibly owned by the seller from the amount of the claimed to be used recycled material that was received by the auditor is equal to zero. The account registered by the seller may also be located in a computing device at another credit system administrator. The computer-readable storage medium may also have computer instructions, that when executed by an administrator's processor, perform the instructions including generating and electronically sending a report to the buyer, the report including the recording of the certificate as retired.

A computer system at an administrator for recording a sale and a retiring of a recycling credit certificate for a recycled material may include a computer system memory and a microprocessor programmed with computer-executable instructions, the instructions including: receiving from a seller a request to generate the recycling credit certificate, transferring the certificate from an account registered by the seller to an account registered by the buyer, receiving from the buyer a request to retire the recycling credit certificate, and recording the certificate as retired. The certificate may include unique information identifying environmental attributes that are unbundled from a corresponding amount of the recycled material, the corresponding amount of the recycled material being tangibly owned by the seller. The request to retire the certificate may include an amount of standard manufactured material used in an amount of product bearing a retail product claim for the environmental attributes that were unbundled from the corresponding amount of the recycled material tangibly owned by the seller.

The recycled material and the standard manufactured material may also be aluminum, steel, paperboard, plastic, or glass and at least one of the buyer and the seller may also be aluminum, steel, paperboard, plastic, or glass packaging manufacturers. The computer-executable instructions may further include receiving from a recycling center an amount of the recycled material that was produced by the recycling center. The computer-executable instructions may further include subtracting the amount of the recycled material tangibly owned by the seller from the amount of the recycled material that was produced by the recycling center. The computer-executable instructions may further include verifying that the result of subtracting the amount of the recycled material tangibly owned by the seller from the amount of the recycled material that was produced by the recycling center is equal to zero. The computer-executable instructions may further include establishing the account registered by the seller and the account registered by the buyer. The computer-executable instructions may further include receiving from the seller a request to list in an electronic market system the amount of the recycled material. The computer-executable instructions may further include listing the amount of the recycled material in the electronic market system.

The computer-executable instructions may further include receiving from an auditor an amount of the recycled material that was claimed to be used in retail products shipped by the buyer. The computer-executable instructions may further include subtracting the amount of the recycled material tangibly owned by the seller from the amount of the claimed to be used recycled material that was received from the auditor. The computer-executable instructions may further include verifying that the result of subtracting the amount of the recycled material tangibly owned by the seller from the amount of the claimed to be used recycled material that was received by the auditor is equal to zero. The account registered by the seller may also be located in a computing device at another credit system administrator.

One implementation of the present invention encompasses one or both of the buyer and seller being aluminum packaging manufacturers (for example, aluminum beverage can or foil pouch manufacturers) or steel packaging manufacturers (for example, manufacturers of conventional food and aerosol cans). In other implementations, the present invention contemplates the recycled material and the standard manufactured material being any other type of material not explicitly mentioned herein. For example, other implementations may include the recycled paperboard, plastic, or glass.

### BRIEF DESCRIPTION OF THE DRAWINGS

The present technology provides a credit system for collection of recycled materials and related methods for making and using the credit system. The technology will now be described in more detail, by way of example only, with reference to the accompanying drawings, in which:

FIG. 1 is a diagram of the flow of electronic information between the administration system and its users, and the flow of tangible material and retail products between the users of the administration system;

FIG. 2 is an example computing environment on which an example embodiment of a credit system for collection of recycled materials may be implemented;

FIG. 3 is an example administration system for managing the credit system for collection of recycled materials in accordance with one example embodiment of the invention; and

FIG. 4 is a flow diagram of an example lifecycle through the administration system for a recycling credit certificate according to an example embodiment of the invention.

### DETAILED DESCRIPTION OF ILLUSTRATIVE EMBODIMENTS

The present invention provides a credit system for collection of recycled materials. The embodiments described below illustrate several aspects of the present invention and are not intended to be limiting.

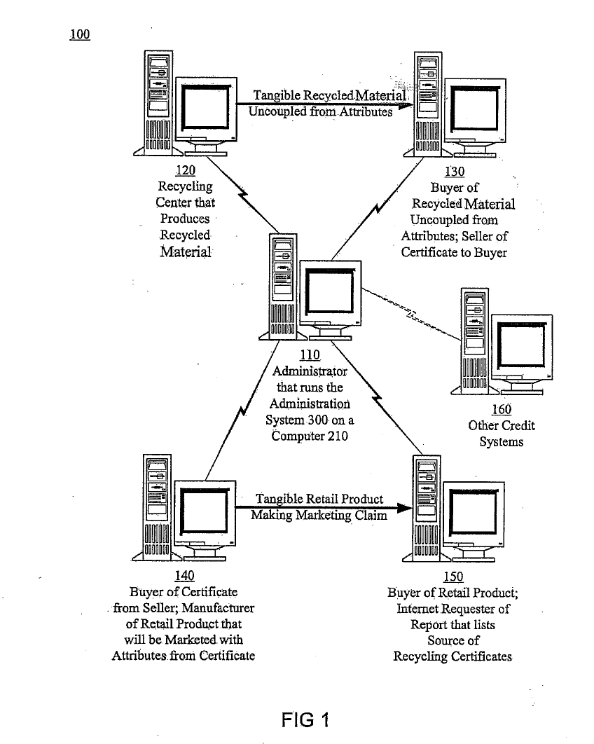

FIG. 1 provides a general overview of, a credit system 100 for collection of recycled materials may include an administrator 110, a recycling center 120, a recycled material buyer 130, a certificate buyer 140 and a retail product buyer 150. Administrator 110 operates a computer-based system for issuing, trading, and retiring recycling credit certificates. Recycling center 120 receives used material as an input and produces recycled material to be sold to recycled material buyer 130. Certificate buyer 140 buys standard manufactured material and has customers that would value the attribute of a product which is made from recycled material. Retail product buyer 150 may buy a retail product that makes a marketing claim of being at least partially made from recycled materials and who may request certificate source information from the administration system 300, and other credit systems 160 that may desire to trade certificates with the credit system 100. For example, one or both of the recycled material buyer 130 and the certificate buyer 140 may be aluminum packaging manufacturers (for example, aluminum beverage can or foil pouch manufacturers) or steel packaging manufacturers (for example, manufacturers of conventional food and aerosol cans). Similarly, one or both of the recycled material buyer 130 and the certificate buyer 140 may be paperboard packaging manufacturers (for example, manufacturers of cardboard foodstuff containers), plastic packaging manufacturers (for example, manufacturers of beverage containers), or glass manufacturers (for example, manufacturers of food jars).

The credit system 100 for collection of recycled materials may facilitate transferring credit for the collection of recycled materials from the recycling center 120 and/or the recycled material buyer 130 to the certificate buyer 140. The credit system 100 is a system where purchasers of a particular material (e.g., aluminum, steel, iron, tin, paperboard, plastic, glass or any other type of material for which it may be desirable to transfer recycling credit certificates) may purchase credits for the input of a given tonnage of that material to be sent to a recycling center. The certificate buyer 140 may claim that the material represented by the credits purchased from the recycling center 120 and/or the recycled material buyer 130 has been used as input of recycled material into the material used to make its products. For example, a metal forming company may (i) purchase 500 tons of recycled metal credits, (ii) purchase 1,000 tons of standard manufactured metal, (iii) use the 1,000 tons of standard manufactured metal to produce retail products, and (iv) sell products carrying a label stating that 50% of the metal material included in the products is recycled metal. Similarly, those of skill in the art will appreciate that this system may also be used for recycled paperboard, plastic, or glass. In this context, plastic refers to any type of polymer capable of comprising at least part of a recycled polymer or a recycled polymer that is formed at least in part from a polymer. A manufacturer that uses paperboard, plastic, or glass in its product may, by way of example, (i) purchase a given weight of recycled material credits, (ii) purchase the standard manufactured materials, (iii) use these materials to produce retail products, and (iv) sell products claiming that a portion of the material included in the products is recycled material. It will be further understood that alternate embodiments may measure the recycling credits in quantifying units other than various weight measurements, including but not limited to volume measurements such as cubic yards or gallons.

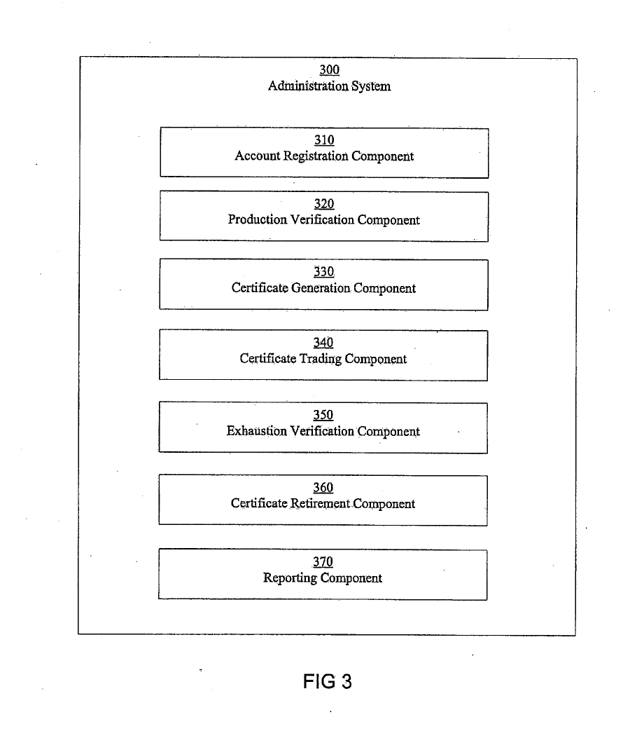

The credit system 100 provides a mechanism to allow recycled material credit certificates to become a separate commodity from the tangible recycled material produced by the recycling center 120. The recycled attributes of the credits, therefore, are unbundled from the tangible recycled material that gave rise to the credits. The recycling credits may then be sold separately as a commodity into a marketplace, such as the certificate trading component 340 of the administration system 300 shown in FIG. 3. With recycling credits, the tangible material from the recycling center 120 is not physically delivered to the certificate buyer 140, but the environmental benefits created by the recycling center 120 are attributed to the tangible standard manufactured material that is separately purchased by the certificate buyer 140, directly offsetting the environmental impact of the certificate buyer 140's purchase of standard manufactured material. Such credits may help overcome the obstacle of delivering the perceived benefits of recycled material to certificate buyers 140 who may be far away from recycling centers 120. The certificate buyer 140 becomes the owner of the environmental attributes of the recycled material.

The credit system 100 may provide an efficient mechanism for recycled material buyers 130 that purchase material for forming and inclusion into tangible retail products in some industries (e.g., automobile manufacturing) to receive compensation for manufacturing attributes that are not valued by their retail customers, but that may be valued by certificate buyer 130's retail consumers in other industries (e.g., aluminum beverage can manufacturers or steel, paperboard, plastic, or glass food and beverage packaging manufacturing). The credit system 100 may provide a market to more easily connect such potential buyers and sellers of these manufacturing attributes. The system may help certificate buyers 140 in certain industries acquire the attributes needed to satisfy consumer preferences, but at a lower price than if they had to purchase recycled material directly from recycling centers or recycled material processors 120.

By creating a tradable market for the environmental attributes of the material produced by the recycling centers 120, the credit system 100 may add value to the material produced by the recycling centers 120. Creating a credit system 100 that tracks and trades recycling certificates may further encourage proliferation of recycling centers and recycling material that is currently in use.

The administrator 110 is the entity that operates the credit system 100 for the benefit of the recycling center 120, the recycled material buyer 130, and the certificate buyer 140. The administrator may set up the credit system 100 and work with the recycling centers 120, the recycled material buyers 130, and potential certificate buyers 140 to convince the various parties to join the system.

It may be desirable for the administrator 110 to be an entity that has neutral business interests compared to the recycling centers 120, the recycled material buyers 130, and the certificate buyers 140 (such as a jointly-operated industry advocacy group), so that the administrator 110 can have sufficient authority to establish the rules of operation of the credit system 100, enforce the rules of operation, maintain confidentiality of information, accept liability for the accuracy of the information received, and resolve disputes related to the credit system 100 regarding the recycling centers 120, the recycled material buyers 130, and the certificate buyers 140. The administrator 110 may have responsibility for managing the computing environment 200 on which the administrative system 300 operates. The administrator 110 may have the expertise to develop reports regarding the performance of the credit system 100.

It may be desirable that the administrator 110 have adequate sources of funding to operate the credit system. The credit system 100 may be funded by any funding source, including, for example, a state or federal government grant, a one-time or annual enrollment fee to maintain an account in the credit system 100 that is charged to all entities that join (e.g., the recycling centers 120, the recycled material buyers 130, and the certificate buyers 140), a fixed fee to only one of the types of entities that join (e.g., the recycling centers 120, the recycled material buyers 130, or the certificate buyers 140), a volume-based fee that scales payment in proportion to tonnage of material for which a recycling credit certificate represents, a transaction-based fee that charges a fixed payment to each entity that requests that a certificate be issued, purchases a certificate, or sells a certificate, or a combination of the aforementioned funding schemes.

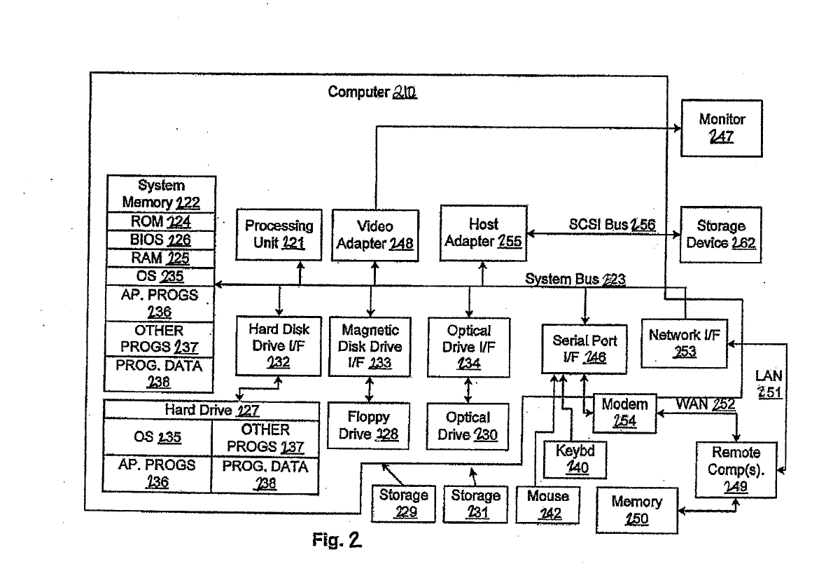

Other credit systems 160 (or other credit system administrators or other administration systems) may exist, and the entities that are members of these other credit systems 160 may desire to trade recycling credit certificates with entities that have joined the credit system 100. To facilitate such cross-system trading, it may be desirable to support some common rules and standards between the credit system 100 and the other credit systems 160. For example, the administrator 110 of the credit system 100 could work with an administrator of the other credit systems 160, to develop a plan to communize the data fields present in the program data 238 (shown in FIG. 2) that is stored in the computer 210, so that the credit system 100 and the other credit systems 160 can easily exchange information.

To prevent double-sale or double-issuance of a single recycling credit certificate (representing the environmental attributes of a single portion of recycled metal) in both the credit system 100 and another credit system 160, it may be desirable to prevent a particular recycling center 120 or a particular recycled material buyer 130 from maintaining membership in more than one credit system 100 or 160 at the same time.

FIG. 2 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation, server or personal computer. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 2 is a block diagram representing a general purpose computer system in which aspects of the present invention and/or portions thereof may be incorporated. As shown, the exemplary general purpose computing system includes a conventional personal computer 210 or the like, including a processing unit 221, a system memory 222, and a system bus 223 that couples various system components including the system memory to the processing unit 221. The system bus 223 may be any of several types of bus structures including a memory bus or memory controller, a peripheral bus, and a local bus using any of a variety of bus architectures. The system memory includes read-only memory (ROM) 224 and random access memory (RAM) 225. A basic input/output system 226 (BIOS), containing the basic routines that help to transfer information between elements within the personal computer 210, such as during start-up, is stored in ROM 224.

The personal computer 210 may further include a hard disk drive 227 for reading from and writing to a hard disk (not shown), a magnetic disk drive 228 for reading from or writing to a removable magnetic disk 229, and an optical disk drive 230 for reading from or writing to a removable optical disk 231 such as a CD-ROM or other optical media. The hard disk drive 227, magnetic disk drive 228, and optical disk drive 230 are connected to the system bus 223 by a hard disk drive interface 232, a magnetic disk drive interface 233, and an optical drive interface 234, respectively. The drives and their associated computer-readable media provide non-volatile storage of computer readable instructions, data structures, program modules and other data for the personal computer 210.

Although the exemplary environment described herein employs a hard disk, a removable magnetic disk 229, and a removable optical disk 231, it should be appreciated that other types of computer readable media which can store data that is accessible by a computer may also be used in the exemplary operating environment. Such other types of media include a magnetic cassette, a flash memory card, a digital video or versatile disk, a Bernoulli cartridge, a random access memory (RAM), a read-only memory (ROM), and the like.

A number of program modules may be stored on the hard disk, magnetic disk 229, optical disk 231, ROM 224 or RAM 225, including an operating system 235, one or more application programs 236, other program modules 237 and program data 238. A user may enter commands and information into the personal computer 210 through input devices such as a keyboard 240 and pointing device 242. Other input devices (not shown) may include a microphone, joystick, game pad, satellite disk, scanner, or the like. These and other input devices are often connected to the processing unit 221 through a serial port interface 246 that is coupled to the system bus, but may be connected by other interfaces, such as a parallel port, game port, or universal serial bus (USB). A monitor 247 or other type of display device is also connected to the system bus 223 via an interface, such as a video adapter 248. In addition to the monitor 247, a personal computer typically includes other peripheral output devices (not shown), such as speakers and printers. The exemplary system of FIG. 2 also includes a host adapter 255, a Small Computer System Interface (SCSI) bus 256, and an external storage device 262 connected to the SCSI bus 256.

The personal computer 210 may operate in a networked environment using logical connections to one or more remote computers, such as a remote computer 249. The remote computer 249 may be another personal computer, a server, a router, a network PC, a peer device or other common network node, and typically includes many or all of the elements described above relative to the personal computer 210, although only a memory storage device 250 has been illustrated in FIG. 2. The logical connections depicted in FIG. 2 include a local area network (LAN) 251 and a wide area network (WAN) 252. Such networking environments are commonplace in offices, enterprise-wide computer networks, intranets, and the Internet.

When used in a LAN networking environment, the personal computer 210 is connected to the LAN 251 through a network interface or adapter 253. When used in a WAN networking environment, the personal computer 210 typically includes a modem 254 or other means for establishing communications over the wide area network 252, such as the Internet. The modem 254, which may be internal or external, is connected to the system bus 223 via the serial port interface 246. In a networked environment, program modules depicted relative to the personal computer 210, or portions thereof, may be stored in the remote memory storage device. It will be appreciated that the network connections shown are exemplary and other means of establishing a communications link between the computers may be used.

Computer 210 typically includes a variety of computer readable storage media. Computer readable storage media can be any available media that can be accessed by computer 210 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 210. Combinations of any of the above should also be included within the scope of computer readable media that may be used to store source code for implementing the flow charts described in detail below.

The credit system for collection of recycled materials in accordance with the invention includes software modules that are loaded into the processing unit 221 of the exemplary computer system of FIG. 2 to implement the characteristic features described in detail below. The software modules will be described with respect to their functional flow as processed by processing unit 221 of the computer system of FIG. 1, for example.

FIG. 3 illustrates, an administration system 300 for the credit system 100 for collection of recycled materials running on the computer 210. By way of example, this process may include an account registration component 310, a production verification component 320, a certificate generation component 330, a certificate trading component 340, an exhaustion verification component 350, a certificate retirement component 360, and a reporting component 370. Each component 310, 320, 330, 340, 350, 360, and 370 may be implemented through execution of applicable program code.

The execution of the applicable program code on the computer 210 may be triggered by, for example, the computer 210 receiving parameters regarding an event relating to the accounts of a recycling center 120, a recycled material buyer 130, a certificate buyer 140, or a member of another credit system 160. For example, the account registration component 310 of the administration system 300 may be executed when a certificate buyer 140 (e.g., a metal forming company or a paperboard, plastic, or glass manufacturer) requests to participate in the credit system 100 by sending parameters related to registration to the computer 210.

The production verification component 320 may be executed when a recycling center 120 or a recycled material buyer 130 reports parameters to the computer 210 of the system 300 relating to the production or purchase of recycled material. The certificate generation component 330 may be executed when a recycling center 120 or a recycled material buyer 130 reports to parameters to the computer 210 of the system 300 relating to the production or purchase of recycled material that reaches a threshold amount for generation of a recycling credit certificate. The certificate trading component 340 may be executed when a recycling center 120 or a recycled material buyer 130 reports parameters to the computer 210 of the system 300 relating to an agreement to sell one or more recycling credit certificates to a certificate buyer 140. The exhaustion verification component 350 may be executed when a certificate buyer 140 that owns one or more recycling credit certificates reports parameters to the computer 210 of the system 300 relating to the certificate buyer 140 shipping products containing a marketing claim associated with a recycling credit certificate. The certificate retirement component 360 may be executed by the computer 210 when the exhaustion verification component 350 identifies that the certificate no longer has a remaining portion based on parameters received by computer 210 relating to the use of the certificate. In this way, the computer 210 has been informed that the maximum amount of products has been verified to have claimed the attributes of a particular certificate. The reporting component 370 may be executed when a recycling center 120, a recycled material buyer 130, or a certificate buyer 140 sends parameters to computer 210 relating to a request for a report of historical information about recycling credit certificates owned, purchased, or sold.

The account registration component 310 may include instructing the computer 210 to receive data corresponding to various data fields that may be included in the program data 238. All parties or entities (e.g., recycling centers 120, recycled material buyers 130, and certificate buyers 140) that desire to use the recycling credit administration system 300 may be required to register by using the account registration component 310 (i.e., the parties or entities may each establish an account in the administration system 300). Such parties that may need to register may include, for example, a recycling center 120 that produces recycled recycled materials, a recycled material buyer 130 that may purchase material from the recycling center 120 for a purpose (e.g., automobile manufacturing) that may not need to use the recycling attributes of the material for marketing to retail customers, a certificate buyer 140 that may purchase recycling credit certificates from the recycled material buyer 130 and/or the recycling center 120, retail customers of the certificate buyer 140 that may desire to verify the recycled material credit source by accessing the accounting system 300 via an internet connection, and entities that are members of other credit systems 160 that desire to buy or sell recycling credit certificates via the administration system 300.

For example, the registration component 310 may take as input parameters identifying information of the various parties or entities (e.g., recycling centers 120, recycled material buyers 130, and certificate buyers 140) that may participate in the recycling credit administration system 300. The information may include, for example, an account holder name, address, contact info, types of metals produced at the facility, and the rate of production of metals produced at the facility.

The production verification component 320 may include instructing the computer 210 to receive parameters related to production information (on which to base the issuance of recycling credit certificates) from a recycling center 120 that takes previously used material as an input and produces recycled material. For example, there may be standardized reporting or record-keeping requirements that the recycling center 120 must follow for governmental regulatory purposes or for ISO (International Organization for Standardization) compliance purposes. For example, the production verification component 320 may request that the recycling center 120 electronically send standardized reporting information, including the types of materials produced, the volume of materials produced, or other relevant production information for a desired period of time (e.g., weekly, monthly, quarterly, or annually). The information submitted to the production verification component 320 may also include information that serves to verify that the recycling center 120's processes meet the relevant quality standards for production of recycled material.

In some cases, the production verification component 320 may include instructing the computer 210 to receive information from the recycling center 120 that is provided by an independent auditor. Such an independent auditor may interview employees of the recycling center 120 and/or visit the recycling center 120 in person to perform a site inspection. For recycling centers 120 that produce relatively small monthly volumes of recycled material s for certificate creation in the administration system 300, it me be less expensive for the operator of the administration system 300 to have production verification component 320 receive self-reported information provided by the recycling center, along with a sworn affidavit, contract, or insurance that may provide additional credibility to the information supplied by the recycling center 120 without an interview or site visit.

The certificate generation component 330 may include instructing the computer 210 to generate electronic recycling credit certificates for eventual use by producers of retail products (e.g., certificate buyers 140), so the producers of the retail products can advertise that their products contain a given percentage of recycled material.

The certificate generation component 330 may include instructions to receive from the administrator 110 a minimum threshold amount of material for certificate generation, e.g., 1 ton of metal. For example, if a recycling center 120 is small, it may not be cost efficient for either the credit system 100 or the certificate buyer 140 to handle or purchase very small recycling credit certificates. Therefore, it may be beneficial to establish a minimum threshold amount of material that can be represented in an individual recycling credit certificate. When a small recycling center 120 can not produce enough material of a particular type during a single week or month, the certificate generation component 330 may be programmed with instructions to allow such a small recycling center 120 to accumulate material over a longer period of time until there is enough material produced to meet or exceed the chosen threshold for certificate generation.

In an exemplary embodiment, the certificate generation component 330 may include instructions to issue to a recycling center 120 or a recycled material buyer 130 one or more standard-weight recycling credit certificates for each amount of material included in the request that may be received by the administration system 300. For example, if the stand-weight certificate size is 1 ton of metal, and a recycled material buyer 130 requests that the certificate generation component 330 issue a recycling credit certificate for 3.7 tons of metal, then the certificate generation component 330 may issue three 1-ton certificates, and the recycled material buyer 130 may wait until a later time to have a certificate issued for the remaining 0.7 tons of metal while additional metal purchases accumulate until the 1-ton threshold for certificate generation is reached again.

The certificate generation component 330 may include instructions to restrict requests for issuance of recycling credit certificates to recycled material buyers 130, rather than allowing recycling centers 120 to request issuance of certificates. Such a restriction may be desirable because it may be difficult for recycling centers 120 to value and sell the unbundled tangible material portion of a particular lot of recycled material if the unbundled environmental attribute portion of the same lot has already been sold to a certificate buyer 140.

Such a restriction may be desirable because it may be difficult for the administration system 300 to track the unbundled tangible material portion and make sure that whoever purchases the tangible material portion has joined the credit system 100, and that whoever purchases the tangible material portion would be subject to the rules of the credit system 100 regarding not advertising the tangible material portion as being recycled. For example, if an unbundled environmental attribute portion is sold to a certificate buyer 140, and an unbundled tangible material portion of the same lot of recycled material is sold to a material buyer that does not participate in the credit system 100, both buyers may claim use of the same recycled metal. Such double-counting of recycled material marketing claims may defraud consumers and devalue the usefulness of the credit system 100.

On the other hand, if the certificate generation component 330 includes instructions to restrict requests for issuance of recycling credit certificates to recycled material buyers 130, then if the recycled material buyer 130 decides to decouple the unbundled tangible material portion and the unbundled environmental attribute portion of a given lot of recycled metal, and the recycled material buyer 130 uses the material portion to make products (e.g., an automobile), while the recycled material buyer 130 sells the environmental attribute portion to a certificate buyer 140 (e.g., a beverage can manufacturer), then it will be much easier to track and enforce the marketing claims made by both the recycled material buyer 130 and the certificate buyer 140, because both entities are members of the credit system 100 and have agreed to be governed by the rules of the credit system 100.

For each lot of recycled material submitted to the administration system 300 by a recycled material buyer 130 for generation of a recycling credit certificate, the certificate generation component 330 may include instructions to generate a unique serial number, and to store other standardized identifying information for tracking by the administration system 300, for example, the name of the recycled material buyer 130 requesting the generation of the certificate, the type of material, the weight of the material, the date of manufacture of the material, the name of the recycling center 120 that processed the material, a certificate expiration date, and any other information that may help to identify the recycling credit certificate.

When each recycling credit certificate is issued by the certificate generation component 330, computer 210 may receive parameters related to where the certificate should be deposited. The parameters may indicate that the certificate may be deposited, for example, into the account of the requesting recycled material buyer 130. To reduce the chance of double-counting recycling credit certificates, the administration system 300 may be programmed such that each individual certificate, identified by a unique serial number, can only be held by the account of one entity at any single time. The administration 300 may be periodically audited by an independent party to verify that each unique credit certificate is only counted once within the credit system 100.

The certificate trading component 340 may include instructing the computer 210 to administer a market system through which the recycling credit certificates can be bought and sold. In an exemplary embodiment, the market system may include an electronic bulletin board, where recycled material buyers 130 could list certificates for sale and the desired asking price, and certificate buyers 140 could list a desire to buy certificates and the amount the buyer 140 is willing to pay. In an exemplary embodiment, the market system may include an electronic auction system, where recycled material buyers 130 could list certificates for sale at an initial price with an undisclosed reserve price, and certificate buyers 140 could bid against each other to determine which buyer 140 would win the obligation to purchase the certificate. In an exemplary embodiment, the market system may include a trading platform with a listed price for recycling credit certificates for each type of material in the credit system 100, similar to a stock exchange price listing, and the listed price could float up or down, depending on supply, demand, and the price paid by the most recent certificate buyers 140. In any of these embodiments including instructions for the computer 210 to administer a market system for trading certificates, recycling centers 120, recycled material buyers 130, and certificate buyers 140 may directly trade certificates, or they may hire agents or brokers to perform the trading function as their representatives.

The certificate trading component 340 may include instructing the computer 210 to split a single recycling credit certificate into two pieces if a certificate buyer 140 wishes to buy only a portion of a certificate that is being offered by a recycled material buyer 130. In such a situation, the original certificate may be sold, but the weight, volume, or other quantifying measurement of the material associated with the original certificate may be reduced to the amount that the certificate buyer 140 wishes to buy, and a new certificate may be issued based on parameters received by the computer 210. The certificate then represents the environmental attributes of the portion of the original certificate that the recycled material buyer 130 would like to retain for potential sale at a future time.

In an exemplary embodiment, the certificate trading component 340 may include instructing the computer 210 to accept sales and purchases of recycling credit certificates from other credit systems 160. The administrator 110 may establish policies and procedures to govern the sales and purchases of certificates between the credit system 100 and other compatible credit systems 160.

The exhaustion verification component 350 may include instructing the computer 210 to monitor the outstanding certificates for exhaustion of the recycling credit certificates. Exhaustion of the certificates may occur when the computer 210 receives parameters relating to an owner of a certificate, e.g., a certificate buyer 140, shiping a sufficient amount of product bearing retail product claims for the environmental attributes of the included material to a wholesaler or retailer. For example, a certificate buyer 140 may ship beverage cans containing a total of 10 tons of metal bearing product claims reflecting a 50% content of recycled aluminum or steel. The certificate buyer 40 may then report parameters to computer 210 that a certificate for the environmental attributes of 5 tons of aluminum or steel has been exhausted. In order to verify that all certificate buyers 140 correctly report exhaustion of certificates to the exhaustion verification component 350, the administrator 110 may request regular production and shipment data from all certificate buyers 140, and an independent auditor may periodically visit all certificate buyers 140, or only the larger certificate buyers 140, to perform an audit of retail product claim and shipment data.

The certificate retirement component 360 may include instructing the computer 210 to retire outstanding recycling credit certificates (remove from active status in the administration system 300, or remove from the group of recycling credit certificates that are available for use) when they have been determined to be exhausted (as described above) or expired.

Expiration of the recycling credit certificates may occur when an owner of a certificate, e.g., a certificate buyer 140, owns a certificate that has reached a predetermined expiration date before the buyer 140 has applied the environmental attributes of the material reflected in the certificate to a shipment of retail product. For example, the administrator 110 may instruct the certificate generation component 330 to issue all certificates with a 5-year time limit for use. In order to prevent expiration of certificates, the reporting component 370 may include instructing the computer 210 to generate and mail a periodic report of outstanding certificates for each certificate buyer 140 and the time remaining until expiration, to serve as a reminder to the buyers 140 to use the certificates before they expire.

The reporting component 370 may include instructing the computer 210 to generate standard (e.g., expiration prevention) or custom reports of the data stored in administration system 300, at previously determined intervals, or upon request by the administrator 110, a recycling center 120, a recycled material buyer 130, a certificate buyer 140, a retail product buyer 150 (to allow the retail product buyer 150 to view the source of recycled material associated with a product claim via a publicly accessible website), or an independent auditor.

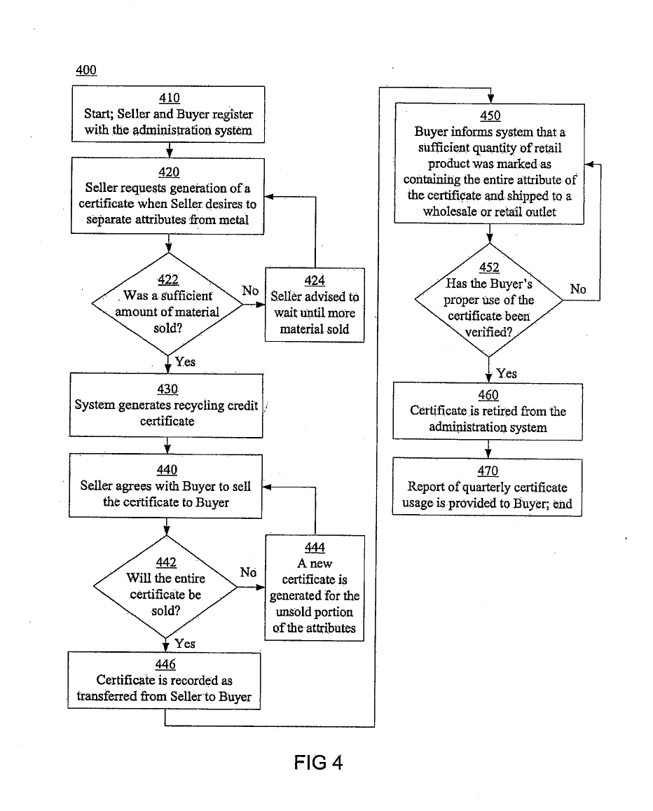

Referring now to FIG. 4, a flow diagram of an example method 400 for execution of the applicable program code to instruct the computer 210 to register the owner of, create, trade, retire, and report information about a recycling credit certificate may include an account registration step 410, a production verification step 420, a certificate generation step 430, a certificate trading step 440, an exhaustion verification step 450, a certificate retirement step 460, and a certificate reporting step 470.

The method may start at account registration step 410 when the administration system 300 receives instructions to register one or more recycling centers 120, recycled material buyers 130 (certificate sellers), and certificate buyers 140. The production verification step 420 may include the administration system 300 receiving a request from a recycled material buyer 130 to generate a recycling credit certificate to be associated with a desired amount of recycled material. At step 422, the administration system 300 may receive instructions to verify whether or not a sufficient amount of material was sold to a recycled material buyer 130 to determine if a recycling credit certificate will be generated. If an insufficient amount of material was sold, at step 424, the administration system 300 may electronically inform the recycled material buyer 130 (certificate seller) to wait until more material has accumulated to reach the threshold for generation of a certificate. The certificate generation step 430 may include the administration system 300 receiving instructions based on parameters to generate a recycling credit certificate with a unique serial number.

The certificate trading step 440 may include the administration system 300 receiving information from the recycled material buyer 130 and/or the certificate buyer 140 that the two parties agree to transfer ownership of the certificate from the recycled material buyer 130 to the certificate buyer 140. At step 442, the administration system 300 may receive instructions to verify whether or not an entire certificate will be sold. If the entire certificate was not sold, at step 444, the administration system 300 may generate a new recycling credit certificate for the unsold portion of the environmental attributes and the system 300 may electronically inform the recycled material buyer 130 (certificate seller) that a new, smaller certificate was issued. If the entire certificate was sold, or if the amount of material associated with the certificate was reduced such that the entire remaining amount of the certificate was sold, at step 446, the administration system 300 may record the certificate as transferred from the account of the recycled material buyer 130 (certificate seller) to the account of the certificate buyer (140).

The exhaustion verification step 450 may include the administration system 300 receiving information from the certificate buyer 140 that a sufficient quantity of retail product was marked as containing the entire environmental attribute of the certificate and shipped to a wholesale or retail outlet. At step 552, the administration system 300 may receive instructions to verify whether or not the certificate buyer 140's use of the certificate was proper, according to the rules of the credit system 100. If the buyer's use was not proper (e.g., the buyer 140's calculation of environmental attributes marked on the retail products does not equal the amount of material associated with the certificate), the administration system 300 may inform the certificate buyer 140 of the mistake, and the administration system may adjust the account of the certificate buyer 140 to reflect a surplus or deficit of environmental attributes associated with a particular type of material. If the certificate buyer 140's use of the certificate was proper, at step 460, the administration system 300 may record the certificate as retired (i.e., no longer active or available for use) from the administration system 300. The method may end at account reporting step 470 when the administration system 300 receives instructions to generate and electronically send a report of quarterly certificate usage to the certificate buyer 140, including the retiring of the certificate from the administration system 300.

The foregoing description is provided for the purpose of explanation and is not to be construed as limiting the invention. While the invention has been described with reference to several embodiments or several methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein.

What is claimed:

1. A method of an administrator recording a sale and a retiring of a recycling credit certificate for a recycled material, the method comprising:
a computing device at the administrator receiving from a seller a request to generate the recycling credit certificate, the certificate including unique information identifying environmental attributes that are unbundled from a corresponding amount of the recycled material, the corresponding amount of the recycled material being tangibly owned by the seller;
the computing device transferring the certificate from an account registered by the seller to an account registered by a buyer;
the computing device receiving from the buyer a request to retire the recycling credit certificate, the request including an amount of standard manufactured material used in an amount of product bearing a retail product claim for the environmental attributes that were unbundled from the corresponding amount of the recycled material tangibly owned by the seller; and
the computing device recording the certificate as retired.

2. The method of claim 1, wherein the recycled material and the standard manufactured material are aluminum or steel, and at least one of the buyer and the seller are aluminum or steel packaging manufacturers.

3. The method of claim 1 wherein the recycled material and the standard manufactured material are paperboard, and at least one of the buyer and the seller are paperboard packaging manufacturers.

4. The method of claim 1 wherein the recycled material and the standard manufactured material are plastic, and at least one of the buyer and the seller are plastic packaging manufacturers.

5. The method of claim 1 wherein the recycled material and the standard manufactured material are glass, and at least one of the buyer and the seller are glass packaging manufacturers.

6. The method of claim 1, further comprising:
the computing device receiving from a recycling center an amount of the recycled material that was produced by the recycling center;
the computing device subtracting the amount of the recycled material tangibly owned by the seller from the amount of the recycled material that was produced by the recycling center; and
the computing device verifying that the result of subtracting the amount of the recycled material tangibly owned by the seller from the amount of the recycled material that was produced by the recycling center is equal to zero.

7. The method of claim 1, further comprising:
the computing device establishing the account registered by the seller and the account registered by the buyer;
the computing device receiving from the seller a request to list in an electronic market system the amount of the recycled material; and
the computing device listing the amount of the recycled material in the electronic market system.

8. The method of claim 1, further comprising:
the computing device receiving from an auditor an amount of the recycled material that was claimed to be used in retail products shipped by the buyer;
the computing device subtracting the amount of the recycled material tangibly owned by the seller from the amount of the claimed to be used recycled material that was received from the auditor; and
the computing device verifying that the result of subtracting the amount of the recycled material tangibly owned by the seller from the amount of the claimed to be used recycled material that was received by the auditor is equal to zero.

9. The method of claim 1, wherein the account registered by the seller is located in a computing device at another credit system administrator.

10. The method of claim 1, further comprising the computing device generating and electronically sending a report to the buyer, the report including the recording of the certificate as retired.

11. A computer-readable storage medium having computer instructions for recording a sale and a retiring of a recycling credit certificate for a recycled material stored thereon, that when executed by an administrator's processor, perform the instructions comprising:
receiving from a seller a request to generate the recycling credit certificate, the certificate including unique information identifying environmental attributes that are unbundled from a corresponding amount of the recycled material, the corresponding amount of the recycled material being tangibly owned by the seller;
transferring the certificate from an account registered by the seller to an account registered by a buyer;
receiving from the buyer a request to retire the recycling credit certificate, the request including an amount of standard manufactured material used in an amount of product bearing a retail product claim for the environmental attributes that were unbundled from the corresponding amount of the recycled material tangibly owned by the seller; and
recording the certificate as retired.

12. The computer-readable medium of claim 11, wherein the recycled material and the standard manufactured material are aluminum or steel, and at least one of the buyer and the seller are aluminum or steel packaging manufacturers.

13. The computer-readable medium of claim 11, wherein the recycled material and the standard manufactured material are paperboard, and at least one of the buyer and the seller are paperboard packaging manufacturers.

14. The computer-readable medium of claim 11, wherein the recycled material and the standard manufactured material are plastic, and at least one of the buyer and the seller are plastic packaging manufacturers.

15. The computer-readable medium of claim 11, wherein the recycled material and the standard manufactured material are glass, and at least one of the buyer and the seller are glass packaging manufacturers.

16. The computer-readable medium of claim 11, the instructions further comprising:
receiving from a recycling center an amount of the recycled material that was produced by the recycling center;
subtracting the amount of the recycled material tangibly owned by the seller from the amount of the recycled material that was produced by the recycling center; and
verifying that the result of subtracting the amount of the recycled material tangibly owned by the seller from the amount of the recycled material that was produced by the recycling center is equal to zero.

17. The computer-readable medium of claim 11, the further instructions further comprising:
establishing the account registered by the seller and the account registered by the buyer;
receiving from the seller a request to list in an electronic market system the amount of the recycled material; and
listing the amount of the recycled material in the electronic market system.

18. The computer-readable medium of claim 11, the instructions further comprising:
receiving from an auditor an amount of the recycled material that was claimed to be used in retail products shipped by the buyer;
subtracting the amount of the recycled material tangibly owned by the seller from the amount of the claimed to be used recycled material that was received from the auditor; and
verifying that the result of subtracting the amount of the recycled material tangibly owned by the seller from the amount of the claimed to be used recycled material that was received by the auditor is equal to zero.

19. The computer-readable medium of claim 11, wherein the account registered by the seller is located in a computing device at another credit system administrator.

20. The computer-readable medium of claim 11, the instructions further comprising generating and electronically sending a report to the buyer, the report including the recording of the certificate as retired.

21. A computer system at an administrator for recording a sale and a retiring of a recycling credit certificate for a recycled material, the computer system comprising:
a computer system memory; and
a microprocessor programmed with computer-executable instructions, the instructions comprising:
receiving from a seller a request to generate the recycling credit certificate, the certificate including unique information identifying environmental attributes that are unbundled from a corresponding amount of the recycled material, the corresponding amount of the recycled material being tangibly owned by the seller;
transferring the certificate from an account registered by the seller to an account registered by a buyer;
receiving from the buyer a request to retire the recycling credit certificate, the request including an amount of standard manufactured material used in an amount of product bearing a retail product claim for the environmental attributes that were unbundled from the corresponding amount of the recycled material tangibly owned by the seller; and
recording the certificate as retired.

22. The computer system of claim 21, wherein the recycled material and the standard manufactured material are aluminum or steel, and at least one of the buyer and the seller are aluminum or steel packaging manufacturers.

23. The computer system of claim 21, wherein the recycled material and the standard manufactured material are paperboard, and at least one of the buyer and the seller are paperboard packaging manufacturers.

24. The computer system of claim 21, wherein the recycled material and the standard manufactured material are plastic, and at least one of the buyer and the seller are plastic packaging manufacturers.

25. The computer system of claim 21, wherein the recycled material and the standard manufactured material are glass, and at least one of the buyer and the seller are glass packaging manufacturers.

26. The computer system of claim 21, wherein the computer-executable instructions further comprise:
receiving from a recycling center an amount of the recycled material that was produced by the recycling center;
subtracting the amount of the recycled material tangibly owned by the seller from the amount of the recycled material that was produced by the recycling center; and
verifying that the result of subtracting the amount of the recycled material tangibly owned by the seller from the amount of the recycled material that was produced by the recycling center is equal to zero.

27. The computer system of claim 21, wherein the computer-executable instructions further comprise:
establishing the account registered by the seller and the account registered by the buyer;
receiving from the seller a request to list in an electronic market system the amount of the recycled material; and
listing the amount of the recycled material in the electronic market system.

28. The computer system of claim 21, wherein the computer-executable instructions further comprise:
receiving from an auditor an amount of the recycled material that was claimed to be used in retail products shipped by the buyer;
subtracting the amount of the recycled material tangibly owned by the seller from the amount of the claimed to be used recycled material that was received from the auditor; and
verifying that the result of subtracting the amount of the recycled material tangibly owned by the seller from the amount of the claimed to be used recycled material that was received by the auditor is equal to zero.

29. The computer system of claim 21, wherein the account registered by the seller is located in a computing device at another credit system administrator.

30. A computer implemented method of recording a sale and a use of an at least one recycling credit certificate for a recycled material, the method comprising:
a computing device receiving at least one set of parameters relating to the environmental attributes of a corresponding amount of tangibly owned recycled material;
the computing device generating a recycling credit certificate;
the computing device recording the certificate in a first account;
the computing device receiving at least one set of parameters relating to a sale of the certificate;
the computing device transferring the certificate from the first account to a second account;
the computing device receiving at least one set of parameters related to a use of the certificate;
the computing device calculating a remaining portion of the certificate; and
the computing device recording the remaining portion of the certificate.

30. The method of claim 30 further comprising the computing device identifying that the certificate no longer has a remaining portion based on receiving at least one set of parameters relating to the use of the certificate and the computing device recording the certificate as retired.

31. The method of claim 30 further comprising the computing device receiving at least one set of parameters related to an amount of recycled material that was produced by the recycling center and the computing device verifying the certificate to ensure accuracy of the credit represented by the certificate.

32. The method of claim 30 further comprising the computing device receiving at least one set of parameters related to an amount of recycled materials claimed to be used in retail products and verifying that the amount matches the amount indicated in the at least one set of parameters related to a use of the certificate.

33. The method of claim 30 further comprising the computing device receiving at least one set of parameters relating to a request for the generation of a report and generating the report.

34. A system for monitoring the creation and use of at least one recycling credit certificate for a recycled material, the system comprising:
a memory that stores at least one set of parameters related to the environmental attributes of a corresponding amount of tangibly owned recycled material, at least one set of parameters relating to a sale of a recycling credit certificate, and at least one set of parameters related to a use of the certificate;
a processor configured to generate the certificate, track ownership of the certificate, and to calculate a remaining portion of the certificate; and
a display for displaying at least one set of parameters relating to existence, ownership, or the remaining portion of the certificate.

35. The system of claim 34 wherein the processor is configured to identify that the certificate no longer has a remaining portion based on receiving at least one set of parameters relating to the use of the certificate and the computing device recording the certificate as retired.

36. The system of claim 34 wherein the processor is configured to receive at least one set of parameters related to an amount of recycled material that was produced by the recycling center and the computing device and to verify the certificate to ensure accuracy of the credit represented by the certificate.

37. The system of claim 34 wherein the processor is configured to receive at least one set of parameters related to an amount of recycled materials claimed to be used in retail products and verifying that the amount matches the amount indicated in the at least one set of parameters related to a use of the certificate.

38. The system of claim 34 wherein the processor is configured to receive at least one set of parameters related to a request for the generation of a report and generating the report.
